(19) United States
(12) Patent Application Publication
(10) Pub. No.: US 2024/0311647 A1
(43) Pub. Date: Sep. 19, 2024

(54) METHOD AND APPARATUS FOR SPLIT LEARNING, ELECTRONIC DEVICE AND MEDIUM

(71) Applicants: Douyin Vision Co., Ltd., Beijing (CN); Lemon Inc., Grand Cayman (KY)

(72) Inventors: Xinwei WAN, Beijing (CN); Jiankai SUN, Los Angeles, CA (US); Shengjie WANG, Los Angeles, CA (US); Lei CHEN, Los Angeles, CA (US); Zhenzhe ZHENG, Beijing (CN); Fan WU, Beijing (CN); Guihai CHEN, Beijing (CN)

(21) Appl. No.: 18/604,023

(22) Filed: Mar. 13, 2024

(30) Foreign Application Priority Data
Mar. 13, 2023 (CN) 202310266370.9

(51) Int. Cl. G06N 3/098; G06N 3/045

(52) U.S. Cl. CPC G06N 3/098; G06N 3/045

(57) ABSTRACT

A method according to embodiments of the present disclosure includes generating a multi-classification label set corresponding to an object set based on a binary classification label set corresponding to the object set. The method further includes receiving an embedding vector set from a non-label party model, wherein an embedding vector in the embedding vector set is generated based on a feature of an object in the object set. The method further includes generating a label party model based on the embedding vector set and the multi-classification label set, wherein the label party model includes a first network and a second network. The method according to embodiments of the present disclosure enables a label party to protect privacy of an original label set under the condition of joint training with a non-label party, and prevent the non-label party from inferring original labels corresponding to original features by various means.

### CROSS-REFERENCE TO RELATED APPLICATION(S)

This application claims priority to Chinese Application No. 202310266370.9 filed Mar. 13, 2023, the disclosure of which is incorporated herein by reference in its entity.

### FIELD

The present disclosure relates to the field of artificial intelligence, and in particular to a method and apparatus for split learning, an electronic device, and a medium thereof.

### BACKGROUND

With development of network technology, people use a variety of applications or products in their work, study and life. For example, people use life service applications to satisfy the needs of dining and travel, use content distribution applications to satisfy the needs of work, study and entertainment, use social applications to communicate with family and friends, and use educational applications to learn knowledge and improve work skills.

During use of different applications and products, users leave behind a mass of user data in these applications and products. As a result, enterprises and institutions may improve user experience of the products through these user data. At present, machine learning technology has been widely applied in all walks of life. The enterprises and the institutions may use the user data as training data and labels in machine learning tasks to train machine learning models. If different enterprises and institutions may agree to aggregate their user data together to jointly train their machine learning models, the efficiency of executing machine learning tasks will be greatly improved. However, because of data privacy related issues, it is extremely difficult to implement data aggregation among different enterprises and institutions.

### SUMMARY

In a first aspect of the present disclosure, a method for split learning is provided. The method includes generating a multi-classification label set corresponding to an object set based on a binary classification label set corresponding to the object set. The method further includes receiving an embedding vector set from a non-label party model, wherein an embedding vector in the embedding vector set is generated based on a feature of an object in the object set. The method further includes generating a label party model based on the embedding vector set and the multi-classification label set.

In a second aspect of the present disclosure, an apparatus for split learning is provided. The apparatus includes a multi-classification label generation module that is configured to generate a multi-classification label set corresponding to an object set based on a binary classification label set corresponding to the object set. The apparatus further includes an embedding vector receiving module that is configured to receive an embedding vector set from a non-label party model, wherein an embedding vector in the embedding vector set is generated based on a feature of an object in the object set. The apparatus further includes a label party model generation module that is configured to generate a label party model based on the embedding vector set and the multi-classification label set.

In a third aspect of the present disclosure, an electronic device is provided. The electronic device includes one or more processors and a storage apparatus. The storage apparatus is configured to store one or more programs. The one or more programs, when being executed by the one or more processors, cause the one or more processors to implement a method for split learning. The method includes generating a multi-classification label set corresponding to an object set based on a binary classification label set corresponding to the object set. The method further includes receiving an embedding vector set from a non-label party model, wherein an embedding vector in the embedding vector set is generated based on a feature of an object in the object set. Furthermore, the method further includes generating a label party model based on the embedding vector set and the multi-classification label set.

In a fourth aspect of the present disclosure, a computer-readable storage medium is provided. The computer-readable storage medium stores a computer program, and the program implements a method for split learning when being executed by a processor. The method includes generating a multi-classification label set corresponding to an object set based on a binary classification label set corresponding to the object set. The method further includes receiving an embedding vector set from a non-label party model, wherein an embedding vector in the embedding vector set is generated based on a feature of an object in the object set. Furthermore, the method further includes generating a label party model based on the embedding vector set and the multi-classification label set.

The section of the summary is provided to introduce a selection of concepts in a simplified form, which will be further described in the detailed description of the embodiments below. The section of the summary is not intended to identify the key features or main features of the subject matter, and also not intended to limit the scope of the subject matter.

### BRIEF DESCRIPTION OF THE DRAWINGS

What are described above and other features, advantages and aspects of each example of the present disclosure will become more apparent in combination with the accompanying drawings and with reference to the following detailed explanations. In the accompanying drawings, same or similar reference numerals represent the same or similar elements. In the figures:

FIG. 1 shows a schematic diagram of an example environment in which multiple embodiments of the present disclosure may be implemented;

FIG. 2 shows a flow chart of a method for split learning according to some embodiments of the present disclosure;

FIG. 3 shows a schematic diagram of a process of flipping a binary classification label set to obtain a flipped binary classification label set according to some embodiments of the present disclosure;

FIG. 4 shows a schematic diagram of a process of generating multi-classification labels for labels in a flipped binary classification label set to obtain a multi-classification label set according to some embodiments of the present disclosure;

FIG. 5 shows a schematic diagram of a process of setting weights for labels in a multi-classification label set according to some embodiments of the present disclosure;

FIG. 6 shows a schematic diagram of a framework for connecting a feedback network and an output network in a parallel manner in a label party model according to some embodiments of the present disclosure;

FIG. 7 shows a schematic diagram of a framework for connecting a feedback network and an output network in a serial manner in a label party model according to some embodiments of the present disclosure;

FIG. 8 shows a block diagram of an apparatus for split learning according to some embodiments of the present disclosure; and

FIG. 9 shows a block diagram of a device capable of implementing multiple embodiments of the present disclosure.

### DETAILED DESCRIPTION OF EMBODIMENTS

It can be understood that data (including, but not limited to, data itself, and acquisition of data or use of data) involved in the present technical solution should comply with the requirements of corresponding laws, regulations and relevant provisions.

Embodiments of the present disclosure will be described in more detail below with reference to the accompanying drawings. Although certain embodiments of the present disclosure are shown in the accompanying drawings, it should be understood that the present disclosure can be implemented in various forms and should not be construed to be limited to the embodiments described herein. On the contrary, these embodiments are provided for a more thorough and complete understanding of the present disclosure. It should be understood that the accompanying drawings and the embodiments of the present disclosure are only for illustrative purposes and are not intended to limit the scope of protection of the present disclosure.

In the description of the embodiments of the present disclosure, the term “including” and similar terms thereof shall be understood to mean open-ended including, i.e. “including, but not limited to.” The term “based on” should be understood as “at least partially based on.” The term “an embodiment” or “the embodiment” should be understood as “at least one embodiment.” The terms “first”, “second”, etc. can refer to different or same objects, unless explicitly stated, and can further include other explicit and implicit definitions below.

As described above, a mass of user data in various applications and products may be generated on a daily basis, and the user data is owned by different enterprises or institutions. In some cases, if different institutions agree to aggregate their owned user data together to jointly train their machine learning models, training efficiency and model performance may be greatly improved. However, it is difficult to aggregate data in practical applications involving privacy. A more extreme but common scenario is that two institutions own feature data and label data respectively, but do not agree to share their owned data with each other. Then, neither a feature owner nor a label owner may train the model separately. For example, a social platform may own basic information about users and data about interests. The social platform may recommend a service of a third-party platform (for example, content platform) that may be of interest to the users according to the user data and provide a link to the third-party platform. The content platform may store data such as whether the user is successfully registered, or whether the user remains active for three days after registration as label data for the user. Both of the social platform and the content platform tend to keep data private in order to protect user privacy and own business interests.

Split learning is a solution of machine learning for privacy protection, and a wide range of attention has been paid to split learning due to growing concern about data privacy. Split learning allows a feature owner and a label owner to train the machine learning model jointly. In the split learning, the entire model is split into two portions. A bottom-level model belongs to the feature owner (which is also referred to as a non-label party), and a top-level model belongs to the label owner (which is also referred to as a label party). The non-label party and the label party jointly train the model without sharing private data (i.e. original features and original labels) with each other. In forward calculation, the non-label party uses the original features as input and calculates a cutting layer embedding. Then, the non-label party sends the cutting layer embedding to the label party instead of sending the original labels to the label party. The label party uses the received cutting layer embedding as input and calculates a predicted classification result. The label party may calculate a loss on based on the predicted classification result and the original labels.

In backpropagation, the label party calculates a gradient vector for the top-level model, and the gradient vector is used for updating the top-level model. In addition, the gradient vector is further used for calculating a gradient vector with respect to the cutting layer embedding. Then the label party sends the gradient vector with respect to the cutting layer embedding back to the non-label party. Based on the received gradient vector, the non-label party may calculate a gradient vector for the bottom-layer model and then update the bottom-layer model by using the gradient vector. In an entire process of split learning, neither the original features nor the original labels are transmitted between the label party and the non-label party. Therefore, split learning may protect privacy to some extent.

However, split learning is not as safe as one might expect. The cutting layer embedding may include information of the original features and even may include information of the original labels. In addition, the gradient vector with respect to the cutting layer embedding that is sent back to the non-label party may include information of the original labels, which may result in the problem of label leakage. In other words, the non-label party may calculate the original labels corresponding to the original features by analyzing the gradient vector with respect to the cutting layer embedding without perception of the label party. The problem of label leakage is common in real-world applications.

To this end, an embodiment of the present disclosure provides a solution for split learning. In the present solution, the label party generates a multi-classification label set based on a real binary classification label set owned by the label party, such that samples in a training sample set may be divided into a plurality of classes. The non-label party generates embedding vectors based on real feature data owned by the non-label party, and sends the embedding vectors to the label party. After receiving the embedding vectors from the non-label party, the label party predicts, using a label party model, a multi-classification result of the samples based on the embedding vectors. Then, the label party optimizes the label party model base on the generated multi-classification label set and the predicted multi-classification result.

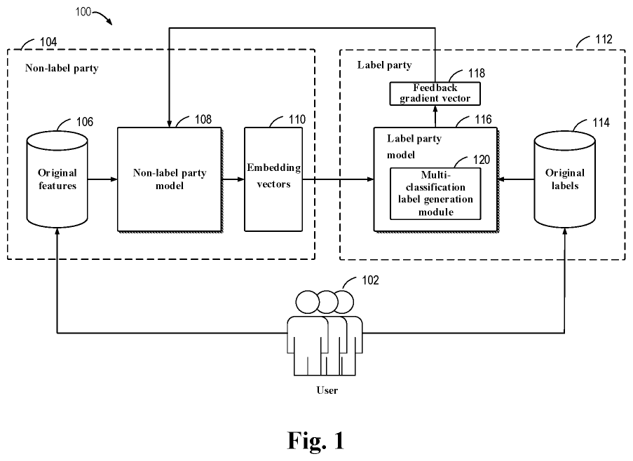

FIG. 1 shows a schematic diagram of an example environment 100 in which multiple embodiments of the present disclosure may be implemented. In FIG. 1, a non-label party 104 and a label party 112 may be two different institutions or entities and own different data for a user 102. Although the user 102 is depicted as a human user in an example shown in FIG. 1, a method described according to the present disclosure is applicable to any subject, for example, human users, objects, music, articles and animals. The non-label party 104 and the label party 112 need to complete a binary classification machine learning task together using user data owned by both parties. In the binary classification machine learning task, a binary classification task represents that there are only two classes in a classification task, such as 0 and 1. In the present disclosure, 0 is referred to as a negative label, thus, samples labeled as 0 are referred to as negative samples. 1 is referred to as a positive label, thus, samples labeled as I are referred to as positive samples.

In order to protect user privacy, neither the non-label party 104 nor the label party 112 want to directly transmit each owned data to the other. Therefore, both parties jointly train, without sharing each owned data, a non-label party model 108 located at the non-label party 104 and a label party model 116 located at the label party 112, to complete a target binary classification machine learning task. Data of the user 102 owned by the non-label party may be used as feature data for jointly training, i.e. original features 106, while data of the user 102 owned by the label party 112 may be used as label data for jointly training, i.e. original labels 114. The original labels 114 are binary classification labels. In the example shown in FIG. 1, the non-label party 104 may be a social platform, for example. The social platform recommends a service of the label party 112 to a user group having certain user features and provides a jump mode. The label party 112 may be a content platform, for example. After the user jumps from the social platform to the content platform, the content platform may store data such as whether the user is registered or whether the user remains active within three days after registration as label data (i.e., original labels 114) of the user.

As shown in FIG. 1, the non-label party model 108 generates embedding vectors 110 (i.e., the cutting layer embedding described above) by using the original features 106 as input. Then, the embedding vectors 110 are transmitted to the label party 112. In this way, the non-label party 104 transmits information in the original features 106 to the label party 112 by means of the embedding vectors 110 without exposing the original features 106 to the label party 112.

The label party model located at the label party 112 receives the embedding vectors 110 as input, and obtains a classification result for the binary classification task by means of calculation. The label party model 116 iteratively optimizes a neural network in the label party model 116 by comparing differences between the classification results and original labels 114. Moreover, in order to enable the non-label party 104 to optimize a neural network therein labels based on the original labels 114, the label party 112 may calculate a feedback gradient vector 118 and return the feedback gradient vector 118 to the non-label party 104. The feedback gradient vector 118 may indicate a difference between the classification result of a current joint training task and original labels 114, and may help the non-label party model 108 optimize the neural network therein. In this way, the label party 112 may transmit information in the original labels 114 to the non-label party 104 by means of the feedback gradient vector 118 without exposing the original labels 114 to the non-label party 104. Thus, the non-label party 104 and the label party 112 may complete joint training without exposing the original features 106 and the original labels 114 to each other.

During interaction between the non-label party 104 and the label party 112, there may be a problem of label leakage. Label leakage refers to the fact that the non-label party 104 may restore or predict the original labels 114 by inferring the feedback gradient vector 118 based on various methods. In the real world, data imbalance is a common phenomenon. The problem of data imbalance in the binary classification task refers to the fact that a number of samples having a label is significantly less than a number of samples having another label in a training data set. In the present disclosure, for convenience of explanation, it is assumed that a number of positive samples having a positive label is less than a number of negative samples having a negative. For example, in the example of the content platform, a number of users who are still using the platform three days after successful registration (positive samples) is usually much less than a number of users who are no longer using the platform three days after successful registration (negative samples).

In the present disclosure, in a training phase of split learning, for example, x represents the original features 106, f represents the non-label party model 108, f(x) represents the embedding vectors 110, g represents the label party model 116, and y represents the original labels 114. In forward calculation, the non-label party model 108 receives the original features 106 as input to calculate embedding vectors 110 and sends the embedding vectors 110 to the label party model 116. The label party model 116 receives the embedding vectors 110 and calculates logit to output l=g(f(x)). A predicted classification result probability

$$p = sigmoid ( l ) = \frac{1}{1 + {e}^{- l}}$$

is provided by means of sigmoid function. Loss=corss_entropy (p,y)=−ylogp−(1−y)log(1−p) is measured by means of a cross-entropy function. In backpropagation, the label party model 116 calculates a gradient vector with respect to the loss of l, which is represented by ∇ₗLoss. Then, based on a chain rule, the label party model 116 calculates the gradient vector ∇_{g}Loss for the loss of parameters of the label party model 116 and updates the label party model 116. In order to enable the non-label party model 108 to be updated, the label party model 116 calculates and shares a feedback gradient vector 118 about the loss of the embedding vectors 110, which is represented by ∇_{f(x)}Loss. The non-label party model 108 receives the feedback gradient vector 118 to further calculate a gradient vector for the loss of parameters of the non-label party model 108, which is represented by ∇_{f}Loss. Then, the non-label party model 108 is updated based on ∇_{f}Loss. In an inference phase, the non-label party model 108 calculates the embedding vectors 110 and sends the embedding vectors to the label party model 116. Then, the label party model 116 calculates I and provides a final predicted classification result probability p.

In an example, the non-label party 104 may speculate the original labels 114 by analyzing information of an entire batch. For example, the non-label party 104 may divide the batch of samples into two clusters by analyzing characteristics of the embedding vectors 110 or characteristics of the feedback gradient vector 118 in the batch of samples. The non-label party 104 may infer that samples in a cluster having a small number of samples are positive samples, while samples in a cluster having a large number of samples are negative samples. In another example, the non-label party 104 may speculate the original labels 114 by analyzing the embedding vectors 110 or the feedback gradient vector 118 for each single sample. For example, due to data imbalance, a norm (a value representing a magnitude of the gradient vector) of the feedback gradient vector 118 calculated by the label party model 116 for the positive samples is significantly greater than a norm of the feedback gradient vector 118 for the negative samples. Thus, the non-label party 104 may infer the original labels 114 by analyzing the norm of the feedback gradient vector 118.

With reference to FIG. 1, the label party model 116 of the embodiment of the present disclosure includes a multi-classification label generation module 120 capable of converting a binary classification label into a multi-classification label, thereby protecting privacy of a label owned by the label party. Embodiments of the present disclosure protect the privacy of an original binary classification label by generating a multi-classification label for the binary classification label.

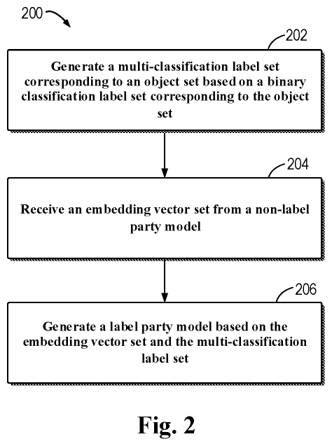

FIG. 2 shows a flow chart of a method 200 for split learning according to some embodiments of the present disclosure. The method 200 may be executed, for example, by the label party model 116 described with reference to FIG. 1. As shown in FIG. 2, at a block 202, the method 200 generates a multi-classification label set corresponding to an object set based on a binary classification label set corresponding to the object set. For example, in an environment 100 shown in FIG. 1, a label party 112 owns a set of original labels 114, and the label party 112 does not want to share the set of the original labels 114 with the non-label party 104. The original labels 114 are a binary classification labels. The method 200 obtains a multi-classification label set corresponding to the original labels 114 set by generating a new multi-classification label for each sample, thereby protecting privacy of the original labels, and preventing the non-label party from speculating the real original labels.

At a block 204, the method 200 receives an embedding vector set from the non-label party model, and an embedding vector in the embedding vector set is generated based on a feature of an object in the object set. For example, in the environment 100 shown in FIG. 1, the non-label party 104 owns a set of the original features 106, and the non-label party 104 does not want to share the set of the original features 106 with the label party 112. Thus, the non-label party 104 may generate the embedding vectors 110 based on the non-label party model 108. In this way, the non-label party 104 may transmit information in the original features 106 to the label party 112 by means of the embedding vectors 110 without exposing the set of the original features 106 to the label party 112.

At a block 206, the method 200 generates a label party model based on the embedding vector set and the multi-classification label set. For example, in the environment 100 shown in FIG. 1, the label party model 116 may include a neural network. The label-party model 116 constructs a loss function for the neural network based on the set of the embedding vectors 110 and the generated multi-classification label set, and iteratively optimizes the label party model 116 such that the label party model 116 can accurately generate a classification result for new embedding vectors.

In this way, the method 200 can enable the label party to protect privacy of the set of the original labels under a condition of joint training with the non-label party, and prevent the non-label party from inferring original labels corresponding to the original features by various means.

Differential privacy is a means of data sharing. Differential privacy may only share some statistical features capable of describing a database without disclosing person-specific information. Differential privacy has been widely used in the field of machine learning. In the present disclosure, an algorithm [symbol] and a fixed differential privacy budget ∈ are given. For any two neighboring data sets D and D′ that differ by only one sample, and any subset S that may be output of [symbol] , if probabilities Pr[ [symbol] (D)∈S] and Pr[ [symbol] (D′)∈S] satisfy the following equation (1), it is said that [symbol] is label differential privacy of ∈:

$$Pr [ ℳ ( D ) ∈ S ] \leq {e}^{ϵ} \cdot Pr [ ℳ ( {D}^{′} ) ∈ S ] \qquad ( 1 )$$

In order to protect the original labels 114 of the label party 112 from being leaked, and to prevent the non-label party 104 from inferring the original labels 114 by analyzing the feedback gradient vector 118, differential privacy may be achieved by using a random response technology. In some embodiments, a label in a subset of the set of the original labels 114 may be flipped. That is, a positive label is flipped to a negative label, or a negative label is flipped to a positive label. In some embodiments, a portion of the original labels may be randomly selected from the set of the original labels 114 at a predetermined probability to form a subset of the original labels 114. Then, each label in the subset is flipped, and the labels external to the subset remain unchanged, thereby obtaining a flipped set of the original labels.

In some embodiments, a multi-classification label set may be further obtained by generating a multi-classification label for each label in the flipped set of the original labels. In some embodiments, the flipped set of the original labels set may be uniformly divided into a plurality of flipped original label subsets. All labels in each flipped original label subset belong to the same class. Then, a new label is generated for each label in each flipped original label subset to obtain a new multi-classification pseudo-label. For example, the set of the original labels 114 may include 1000 labels, of which there are 200 positive labels and 800 negative labels. The 1000 labels may be uniformly divided into 2 subsets including 100 positive labels and 8 subsets including 100 negative labels. Then, 10 new classifications are generated for each of the 10 subsets to form a multi-classification pseudo-label set having 10 classes.

In this way, the original binary classification label set may be converted into a flipped multi-classification label set. Differential privacy may be achieved by randomly selecting a portion of labels from the original binary classification label set to flip. Furthermore, the problem of data label imbalance may be solved by converting the binary classification label set into the multi-classification label set such that the non-label party 104 cannot infer the original labels 114 from analysis of a batch of samples and analysis of a single sample as described above.

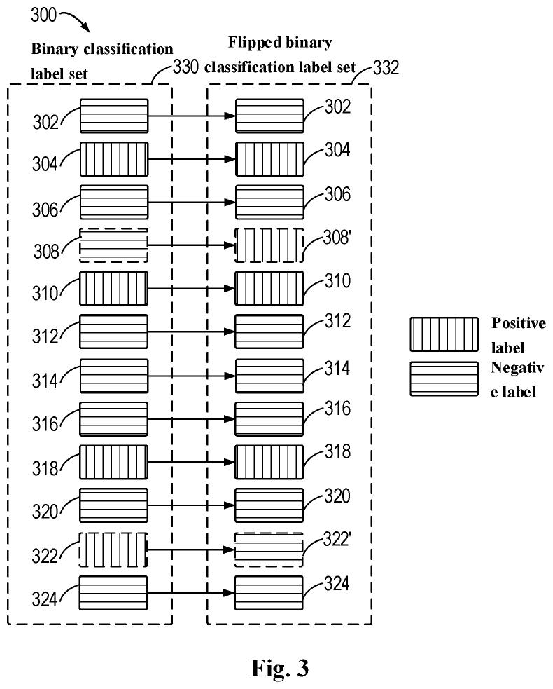

FIG. 3 shows a schematic diagram of a process 300 of flipping a binary classification label set to obtain a flipped binary classification label set according to some embodiments of the present disclosure. As shown in FIG. 3, the binary classification label set 330 includes 10 binary classification labels, in which there are 6 negative labels 302, 306, 308, 312, 314, 316, 320 and 324, and 4 positive labels 304, 310, 318 and 322. For simplicity, only 10 labels are shown in an example of FIG. 3, but the binary classification label set may include any number of labels, and a ratio of positive labels to negative labels may be any ratio. In the example of FIG. 3, the process 300 flips the binary classification label set 330 based on a random response technology to obtain a flipped binary classification label set 332. Random response is a questionnaire survey technology that allows, on one hand, researchers to collect the overall response of population to sensitive questions, and allows, on the other hand, individual respondents to maintain privacy, and is a compromise technique when conducting research on a sensitive topic. For the fixed differential privacy budget ∈, ∈ is greater than 0. A given label value y∈{0, 1} is used as input, a random response function RRE outputs a randomly flipped value \tilde{y} according to a probability distribution Pr of the following equation (2):

$$Pr [ {RR}_{ϵ} ( y ) = \tilde{y} ] = \{ \begin{matrix}\frac{{e}^{ϵ}}{{e}^{ϵ} + 1} , \tilde{y} = y , \\ \frac{1}{{e}^{ϵ} + 1} , \tilde{y} \neq y .\end{matrix} \qquad ( 2 )$$

In FIG. 3, for each label in the binary classification label set 330, the process 300 may flip the label at a predetermined probability, e.g., 0.2. As shown in FIG. 3, the negative label 308 is flipped to the positive label 308′, the positive label 322 is flipped to the negative label 322′, and other labels retain original values of the labels.

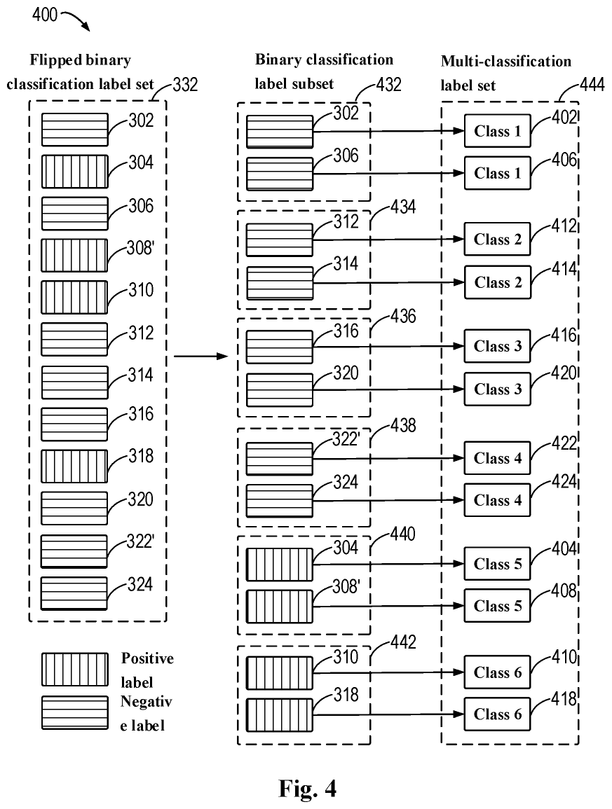

FIG. 4 shows a schematic diagram of a process 400 of generating a multi-classification label for a labels in a flipped binary classification label set 332 to obtain a multi-classification label set according to some embodiments of the present disclosure. Assuming that a ratio of the number of samples having positive labels to samples having negative labels in the binary classification label set is 1:a, that is, Nₚₒₛ positive samples and N_{neg}=a·Nₚₒₛ negative samples exist, the binary classification label set may be divided into K=(1+a)·Kₚₒₛ(Kₚₒₛ, a·Kₚₒₛ∈ [symbol] *) subsets. Then, pseudo-classes k∈{0, . . . , K−1} are generated for the labels in each subset. In the K pseudo-classes, classes 0 to Kₚₒₛ−1 are Kₚₒₛ positive pseudo-classes including positive samples, and classes Kₚₒₛ to K−1 are K_{neg}=K−Kₚₒₛ=a·Kₚₒₛ negative pseudo-classes including negative samples. A multi-classification label may be generated for each training sample according to a probability distribution P, of the following equation (3):

$$Pr [ PMLG ( y , K , {K}_{pos} ) = \hat{y} ] = \{ \begin{matrix}\frac{1}{{K}_{pos}} , 0 \leq \hat{y} < {K}_{pos} and y = 1 , \\ \frac{1}{{K}_{neg}} , {K}_{pos} < \hat{y} < K and y = 0 , \\ 0 , others .\end{matrix} \qquad ( 3 )$$

where y represents a binary classification label, ŷ represents a multi-classification label, and PMLG represents a function that generates multi-classification labels for the samples.

According to equation (3), the expected magnitude E[Nₖ_{_{neg}}] of each negative pseudo-class k_{neg}∈{Kₚₒₛ, . . . , K−1} may be derived according to the following equation (4):

$$\begin{matrix}E [ {N}_{{k}_{neg}} ] = {N}_{neg} \cdot \frac{1}{{K}_{neg}} = ( a \cdot {N}_{pos} ) \cdot \frac{1}{a \cdot {K}_{pos}} \\ = {N}_{pos} \cdot \frac{1}{{K}_{pos}} = E [ {N}_{{k}_{pos}} ] ,\end{matrix} \qquad ( 4 )$$

where E[Nₖ_{ₚₒₛ}] represents the expected magnitude of each positive pseudo-class kₚₒₛ∈0, . . . , Kₚₒₛ−1. Equation (4) shows that the expected magnitude of each pseudo-class k∈{0, . . . , K−1} is the same.

In an example of FIG. 4, the process 400 may uniformly divide the flipped binary classification label set 332 into multiple similar sizes of binary classification label subsets 432, 434, 436, 438, 440 and 442 based on the positive labels and the negative labels. Each binary classification label subset includes the same number of labels. The labels in the binary classification label subsets 432, 434, 436 and 438 are all negative labels, and the labels in the binary classification label subsets 440 and 442 are all positive labels. The process 400 generates multi-classification labels 402 and 406 having values of “class 1” for the negative labels 302 and 306 in the binary classification label subset 432. The process 400 generates multi-classification labels 412 and 414 having values of “class 2” for the negative labels 312 and 314 in the binary classification label subset 434. The process 400 generates multi-classification labels 416 and 420 having values of “class 3” for the negative labels 316 and 320 in the binary classification label subset 436. The process 400 generates multi-classification labels 422 and 424 having values of “class 4” for negative labels 322′ and 324 in the binary classification label subset 438. The process 400 generates multi-classification labels 404 and 408 having values of “class 5” for the positive labels 304 and 308 ′ in the binary classification label subset 440, and generates multi-classification labels 410 and 418 having values of “class 6” for the positive labels 310 and 318 in the binary classification label subset 442. Thus, the process 400 may generate the multi-classification label set 444 based on the flipped binary classification label set.

In some examples, in order to reduce label leakage caused by data imbalance, adverse effects caused by data imbalance may be reduced by using an upsampling technology. In some embodiments, a ratio of a number of positive labels to a number of negative labels in the binary classification labels may be determined. Then, a weight may be set for the labels in the multi-classification label set based on the ratio of the number of the positive labels to the number of the negative labels. In some embodiments, a ratio of a weight of multi-classification labels corresponding to positive labels in a binary classification label set to a weight of multi-classification labels corresponding to negative labels in the binary classification label set may be inversely proportional to a ratio of the number of the positive labels to the number of the negative labels in binary classification labels. The contribution of the labels with a relatively small proportion and associated with the positive labels made to model training may be increased by increasing the weight of the labels, thereby the accuracy of the model may be improved. Moreover, a non-label party cannot infer real labels of the samples by analyzing the norm of the feedback gradient vector.

As described above, the feedback gradient vector ∇_{f(x)}Loss=∇ₗLoss·∇_{f(x)}l=(p−y)·∇_{f(x)}l may be obtained from a predicted classification result probability p=sigmoid(l) and loss Loss=cross_entropy(p, y). Due to imbalance in data, the positive samples are rare. Therefore, a prediction bias for the positive samples is greater compared with prediction for the negative samples, resulting in a larger value of |p−y| for the positive samples. In addition, the positive samples have a larger ∥∇_{f(x)}Loss∥₂ than the negative samples because ∥∇_{f(x)}l∥₂ of the positive samples and the negative samples have similar distributions. Thus, the non-label party may accurately infer the original labels 114 based on the received feedback gradient vector 118. In some examples, a high weight may be set for the positive samples. Assuming that a ratio of the positive samples to the negative samples is 1:a, the weight of the positive samples may be set to a, and the weight of the negative samples may be set to 1.

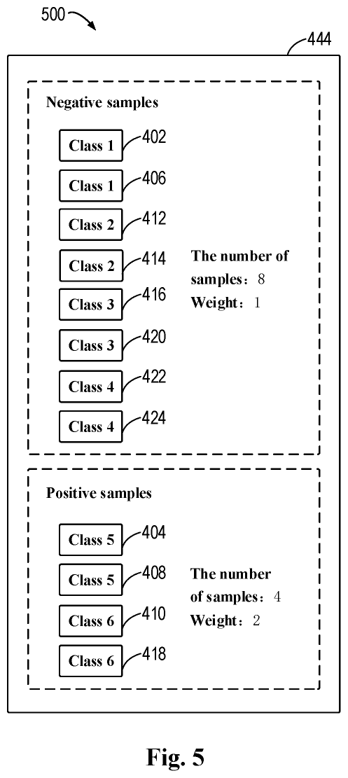

FIG. 5 shows a schematic diagram of a process 500 of setting weights for labels in a multi-classification label set 414 according to some embodiments of the present disclosure. As shown in FIG. 5, the multi-classification label set 444 has a total of 12 labels, and includes 8 multi-classification labels (multi-classification labels 402, 406, 412, 414, 416, 420, 422 and 424) generated for negative samples, and 4 multi-classification labels (multi-classification labels 404, 408, 410 and 418) generated for positive samples. In an example of FIG. 5, a ratio of the number of labels associated with positive samples to the number of labels associated with negative samples is 1:2. Therefore, a weight of the positive samples (i.e. samples having multi-classification labels 404, 408, 410 and 418) may be set to 2, and a weight of the negative samples (i.e. samples having multi-classification labels 402, 406, 412, 414, 416, 420, 422 and 424) may be set to 1. A weight may be used when the loss of the model is calculated, and changes a feedback gradient vector for the positive samples, such that a non-label party may not infer an original label by analyzing a norm distribution of the feedback gradient vector, thereby strengthening privacy protection for the original labels. Furthermore, as the number of the positive samples in a real-world data set tends to be small, there is no need to worry about overfitting caused by upsampling of the positive samples.

In some cases, accuracy of a model may be reduced as a result of strengthening protection of the original labels. In order to ensure that the accuracy of the model is minimally adversely affected while protecting privacy of the original labels, in an embodiment of the present disclosure, the label party model 116 may be constructed by using two neural networks. A feedback network uses multi-classification labels to generate a feedback gradient vector sent to a non-label party, so as to protect label privacy. An output network uses the original labels to calculate a predicted classification result output by the label party model, so as to improve performance and accuracy of the model. In some embodiments, the feedback network and the output network may be connected in parallel. In these embodiments, the label party model 116 trains the output network by using embedding vectors as training data of the output network. In this way, the output network may have high accuracy. In some other embodiments, the feedback network and the output network may be connected in series. In these embodiments, the output network may be simplified into a neural network having only one layer, and the label party model 116 may train the output network by using a multi-classification result predicted by the feedback network as training data of the output network. Thus, calculation cost and storage cost of the label party model 116 may be saved.

In some embodiments, a label party model 116 may receive embedding vectors 110 from a non-label party model 108. Then, the label party model 116 inputs the embedding vectors 110 into a feedback network, and the feedback network outputs a predicted multi-classification result. Then, the label party model 116 generates a loss function for the feedback network based on multi-classification labels generated according to the original labels 114 and the output multi-classification result. Then, the label party model 116 trains the feedback network based on the loss function for the feedback network.

In some embodiments, a label party model 116 may calculate a feedback gradient vector 118 with respect to the loss of embedding vectors 110 based on the embedding vectors 110, a multi-classification result output by the feedback network, and the multi-classification labels. Then, the label party model 116 may send the feedback gradient vector 118 to the non-label party 104, such that the non-label party 104 may update a parameter of the non-label party model 108 based on the feedback gradient vector 118. In these embodiments, privacy of the original labels 114 may be protected by using multi-classification labels generated based on the original labels 114.

In some embodiments, the label party model 116 may connect the feedback network and the output network in parallel. The label party model 116 may generate a loss function for the output network based on embedding vectors 110, a binary classification result output by the output network, and original labels 114. Then, the output network is trained by using the loss function. In some embodiments, the label party model 116 may input the embedding vector s110 into the output network, and the output network outputs a predicted binary classification result. Then, the label party model 116 generates a loss function for the output network based on the predicted binary classification result and the original labels 114. Then, the label party model 116 trains the feedback network by using the loss function for the output network. In these embodiments, the accuracy of the predicted binary classification result can be ensured by training the output network to predict the binary classification result based on the embedding vectors 110 and the original labels 114.

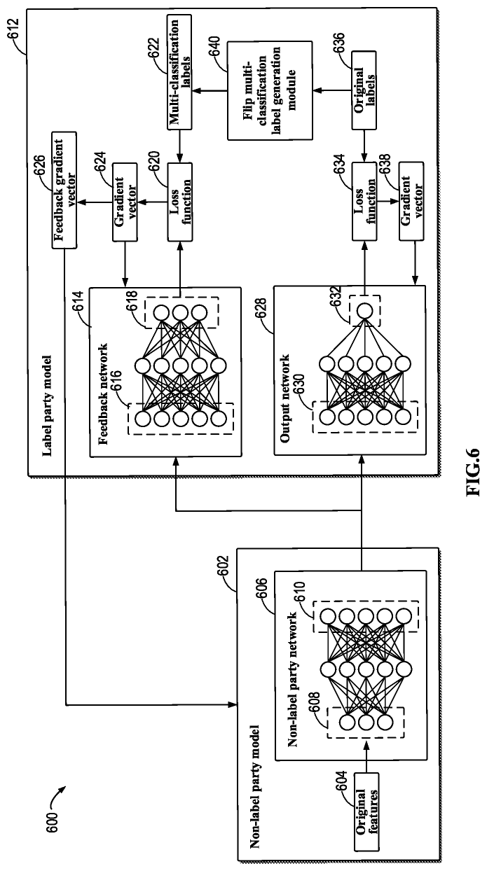

FIG. 6 shows a schematic diagram of a framework 600 for connecting a feedback network and an output network in a parallel manner in a label party model according to some embodiments of the present disclosure. As shown in FIG. 6, the framework 600 includes a non-label party model 602 and a label party model 612. The non-label party model 602 includes a non-label party network 606. For a sample (xᵢ, yᵢ, ŷᵢ), xᵢ represents an original feature of the sample, yᵢ represents an original binary classification label of the sample, and ŷᵢ represents a multi-classification label generated for the sample. The non-label network 606 receives the original features 604 of the sample as input 608 and outputs embedding vectors 610. The embedding vectors 610 are represented as f(xᵢ). The label party model 612 includes a feedback network 614 and an output network 628. The feedback network 614 is represented as g₁, and the output network 628 is represented as g₂. The feedback network 614 receives the embedding vectors 610 as input 616, and a fully connected layer 618 outputs a predicted multi-classification result. In the process, logit output of the feedback network is represented as l_{1,i}=g₁(f(xᵢ))=[l_{1,i,0}, . . . , l_{1,i,K-1}]. l_{1,i,j}(j∈{0, . . . , K-1}) represents logit output of class j. A predicted probability p_{1,i,j} that a sample having the original feature xᵢ is classified into class j may be calculated through a softmax function according to the following equation (5):

$${p}_{1 , i , j} = softmax ( j , {l}_{1 , j} ) = \frac{{e}^{{l}_{1 , i , j}}}{{\sum }_{t = 0}^{K - 1} {e}^{{l}_{1 , i , j}}} . \qquad ( 5 )$$

The label party model 612 may further include a flip multi-classification label generation module 640. Before training is started, the flip multi-classification label generation module 640 randomly flips a set of original labels 636 and generates a set of multi-classification labels 622 for the original label set. An objective of the feedback network 614 is to make a correct classification based on the generated multi-classification labels 622, to maximize the predicted probability p_{1,i,ŷ}_{ᵢ} of a target class. The loss function Loss_{g}_{₁}(x, ŷ) for the process is shown in the following equation (6):

$${Loss}_{{g}_{1}} ( x , \hat{y} ) = - \frac{1}{N} {\sum }_{i}^{N} {weight}_{i} \cdot log {p}_{1 , i , {\hat{y}}_{i}} \qquad ( 6 )$$

where N is the number of training samples, and weightᵢ is an upsampling weight of an i-th sample. For example, in an example of FIG. 5, a weight of negative samples having labels 402 is 1, and a weight of positive samples having labels 404 is 2.

The output network 628 receives the embedding vectors 610 as input 630 and outputs the predicted binary classification result 632. In the process, logit output of the output network 628 is l_{2,i}=g₂(f(xᵢ)). The predicted probability p_{2,i} that a sample with the original feature xᵢ is classified as a positive sample may be calculated based on a sigmoid function according to the following equation (7):

$${p}_{2 , i} = sigmoid ( {l}_{2 , i} ) = \frac{1}{1 + {e}^{- {l}_{2 , i}}} \qquad ( 7 )$$

An objective of the output network 628 is to make a correct classification based on the real original label 636. That is, p_{2,i} is maximized when yᵢ=1 (positive sample), and p_{2,i} is minimized when yᵢ=0 (negative sample). The loss function Loss_{g}_{₂}(x, y) for the process is shown in the following equation (8):

$${Loss}_{{g}_{2}} ( x , y ) = - \frac{1}{N} {\sum }_{i}^{N} ( {y}_{i} \cdot log {p}_{2 , i} + ( 1 - {y}_{i} ) \cdot log ( 1 - {p}_{2 , i} ) ) \qquad ( 8 )$$

In an example shown in FIG. 6, both of the non-label party model 602 and the label party model 612 update parameters of neural networks therein by using a gradient descent algorithm. The label party model 612 calculates a gradient vector 624 (which is represented by ∇_{g}_{₁}Loss_{g}_{₁}) with respect to the loss Loss_{g}_{₁} of parameters of the feedback network 614 by using a loss function 620 to update the feedback network 614. The label party model 612 further calculates a gradient vector 638 (which is represented by ∇_{g}_{₂}Loss_{g}_{₂}) with respect to the loss Loss_{g}_{₂} of the output network 628 through a loss function 634 to update the output network 628. The label party model 612 further calculates the feedback gradient vector 626 (which is represented by ∇_{f(x)}Loss_{g}_{₁}) with respect to the loss Loss_{g}_{₁} of the embedding vectors 610 by using the gradient vector 624 and the embedding vectors 610 and sends the feedback gradient vector 626 back to the non-label party 602. After receiving the feedback gradient vector 626, the non-label party model 602 may calculate the gradient vector (which is represented by ∇_{f}Loss_{g}_{₁}) with respect to the loss of parameters of the non-label party network 606 to update the non-label party network 606.

As the label party and the non-label party communicate using a gradient vector, and the gradient vector is calculated by the label party using randomly flipped multi-classification labels, privacy of the original labels owned by the label party is protected. Even in the worst condition, if the non-label party accurately infers the flipped label in some way, the non-label party may not accurately infer the real original label, because the flipped label is randomly flipped on the set of the real original labels.

In an inference phase of the embodiment described above, the label party 112 may no longer use the feedback network 614, but may instead execute a prediction task only through the output network 628. For a given sample (xᵢ, yᵢ), a probability p(xᵢ) of the predicted classification result may be calculated through the following equation (9):

$$p ( {x}_{i} ) = sigmoid ( {g}_{2} ( f ( {x}_{i} ) ) ) \qquad ( 9 )$$

In some embodiments, a label party model 116 may connect a feedback network and an output network in series. The label party model 116 may generate a loss function for the output network based on embedding vectors 110, the feedback network, and original labels 114. Then, the output network is trained based on the loss function. In some embodiments, the label party model 116 may input embedding vectors 110 into a feedback network, and the feedback network outputs a predicted multi-classification result. Then, the multi-classification result predicted by the feedback network is input to the output network, and a predicted binary classification result is output by the output network. Then, the label party model 116 may generate a loss function for the output network based on the predicted binary classification result and the original labels 114. Then, the label party model 116 trains the feedback network based on the loss function for the output network. In these embodiments, a network structure of the output network may be simplified by connecting the output network in series after the feedback network, thereby reducing calculation cost and storage costs of the label party 112.

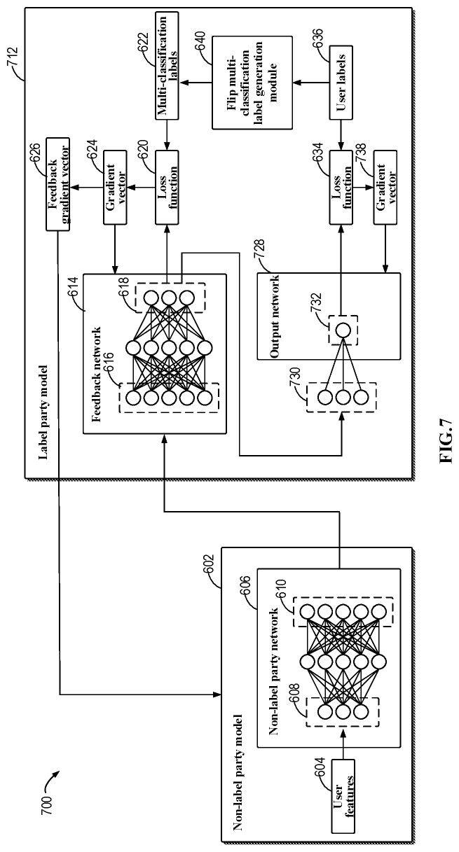

FIG. 7 shows a schematic diagram of a framework 700 for connecting a feedback network 714 and an output network 728 in a serial manner in a label party model according to some embodiments of the present disclosure. As shown in FIG. 7, the framework 700 includes a non-label party model 602 and a label party model 712. The non-label party model 602 includes a non-label party network 606. The non-label network 606 receives original features 604 of a sample as input 608 and outputs embedding vectors 610. The label party model 712 includes a feedback network 614 and an output network 728. The feedback network 614 receives the embedding vectors 610 as input 616, and a fully connected layer 618 outputs a predicted multi-classification result. The label party model 712 further includes a flip multi-classification label generation module 640. Before training is started, the flip multi-classification label generation module 640 randomly flips a set of the original labels 636 and generates a set of multi-classification labels 622 for the set of the original labels.

Different from the example shown in FIG. 6, the output network 728 has only one linear layer. The output network 728 receives the multi-classification result predicted by the feedback network 614 as input 730. For example, the feedback network 614 may use logit output l_{1,i}=g₁(f(xᵢ))=[l_{1,i,0}, . . . , l_{1,i,K-1}] of the feedback network 614 as input 730. The fully connected layer 732 outputs the predicted binary classification result, and the predicted binary classification result may be represented by the logit output l_{2,i}=g₂(g₁(f(xᵢ))). Similar to the example shown in FIG. 6, the predicted probability for the feedback network 614 may be calculated through the equation (5). The predicted probability for the output network 728 may be calculated through equation (7), and the loss function 620 for the feedback network may be calculated through equation (6). The loss function 634 for the output network may be calculated through equation (8). The label party model 612 calculates a gradient vector 624 through the loss function 620 to update the feedback network 614. The label party model 612 further calculates the gradient vector 738 through the loss function 634 to update the output network 728. The label party model 612 further calculates a feedback gradient vector 626 through the gradient vector 624 and the embedding vectors 610 and sends the feedback gradient vector 626 back to the non-label party 602. After receiving the feedback gradient vector 626, the non-label party model 602 may calculate a gradient vector for the loss of parameters of the non-label party network 606 to update the non-label party network 606. In an inference phase of the embodiment described above, both the feedback network 614 and the output network 628 are maintained and a probability p(xᵢ) of the predicted classification result may be calculated through the following equation (10):

$$p ( {x}_{i} ) = sigmoid ( {g}_{2} ( {g}_{1} ( f ( {x}_{i} ) ) ) ) \qquad ( 10 )$$

In the embodiment described above, the feedback network 614 and the output network 628 are connected in series, such that the output network may be simplified into a neural network having only one layer, thereby saving calculation cost and storage cost of the label party model.

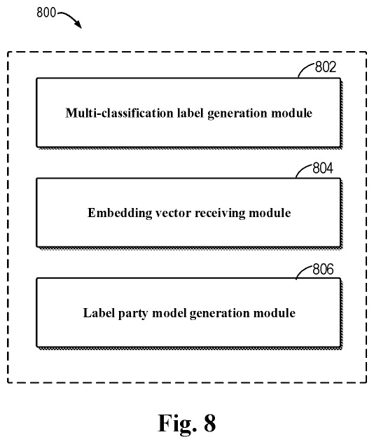

FIG. 8 shows a block diagram of an apparatus 800 for split learning according to some embodiments of the present disclosure. As shown in FIG. 8, the apparatus 800 includes a multi-classification label generation module 802, configured to generate a multi-classification label set corresponding to an object set based on a binary classification label set corresponding to the object set. The apparatus 800 further includes an embedding vector receiving module 804, configured to receive an embedding vector set from a non-label party model, in which an embedding vector in the embedding vector set is generated based on a feature of an object in the object set. The apparatus 800 further includes a label party model generation module 806, configured to generate a label party model based on the embedding vector set and the multi-classification label set, where the label party model includes a first network and a second network. The apparatus 800 may further include other modules to implement the steps of the method 200 according to embodiments of the present disclosure, which will not be repeated herein for simplicity.

It may be understood that at least one of multiple advantages that may be achieved by the method or process described above may be achieved by means of the apparatus 800 of the present disclosure. For example, privacy of original labels may be protected to prevent a non-label party from inferring the original label from information returned by a label party.

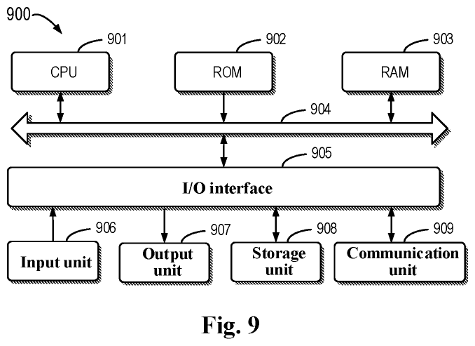

FIG. 9 shows a block diagram of an electronic device 900 according to some embodiments of the present disclosure. The device 900 may be a device or apparatus described in the embodiments of the present disclosure. As shown in FIG. 9, the device 900 includes a central processing unit (CPU) 901 and/or a graphics processing unit (GPU) that may execute various suitable actions and processes according to computer program instructions stored in a read only memory (ROM) 902 or computer program instructions loaded from a storage unit 908 into a random access memory (RAM) 903. Various programs and data required for operations of the device 900 may further be stored in the RAM 903. The CPU/GPU 901, the ROM 902 and the RAM 903 are connected to each other by means of a bus 904. An input/output (I/O) interface 905 is also connected to the bus 904. The device 900 may further include a coprocessor although the coprocessor is not shown in FIG. 9.

A plurality of components in the device 900 are connected to the I/O interface 905, including: an input unit 906, such as a keyboard and a mouse; an output unit 907, such as various types of displays and loudspeakers; a storage unit 908, such as a magnetic disk and an optical disk; and a communication unit 909, such as a network card, a modem and a wireless communication transceiver. The communication unit 909 allows the device 900 to exchange information/data with other devices by means of a computer network, such as Internet, and/or various telecommunication networks.

Various methods or processes described above may be executed by the CPU/GPU 901. For example, in some embodiments, the method may be implemented as computer software programs that are physically included in a machine-readable medium, such as the storage unit 908. In some embodiments, part or all of computer programs may be loaded into and/or mounted on the device 900 by means of the ROM 902 and/or the communication unit 909. When the computer programs are loaded into the RAM 903 and are executed by the CPU/GPU 901, one or more steps or actions of the method or process described above may be executed.

In some embodiments, the method and process described above may be implemented as a computer program product. The computer program product may include a computer-readable storage medium loading computer-readable program instructions for executing various aspects of the present disclosure.

The computer-readable storage medium may be a tangible device that may be used for maintaining and storing the instructions used by an instruction execution device. The computer-readable storage medium may be, but is not limited to, an electrical storage device, a magnetic storage device, an optical storage device, an electromagnetic storage device, a semiconductor storage device, or any suitable combination of the above, for example. More specific examples (a non-exhaustive list) of the computer-readable storage medium may include: a portable computer disk, a hard disk, a RAM, a ROM, an erasable programmable read only memory (EPROM or flash memory), a static random access memory (SRAM), a portable compact disk read only memory (CD-ROM), a digital versatile disk (DVD), a memory stick, a floppy disk, a mechanical encoding device, a punched card or protrusion-in-groove structure storing instructions, for example, and any suitable combination of the above. The computer-readable storage medium used herein is not to be construed as a transient signal per se, such as a radio wave or other electromagnetic waves freely propagated, an electromagnetic wave (e.g., an optical pulse passing through a fiber optic cable) propagated through a waveguide or other transmission media, or an electrical signal transmitted through an electrical wire.

The computer-readable program instructions described herein may be downloaded from the computer-readable storage medium to various computing/processing devices, or to an external computer or external storage device via a network, such as the Internet, a local area network (LAN), a wide area network (WAN), and/or a wireless network. The network may include a copper transmission cable, fiber optic transmission, wireless transmission, a router, a firewall, a switch, a gateway computer and/or an edge server. A network adapter card or a network interface in each computing/processing device may receive the computer-readable program instructions from the network and forwards the computer-readable program instructions, so as to store the computer-readable program instructions in computer-readable storage media in various computing/processing devices.

The computer program instructions for executing operations of the present disclosure may be assembly instructions, instruction set architecture (ISA) instructions, machine instructions, machine-related instructions, microcode, firmware instructions, state setting data, or source code or object code written in any combination of one or more programming languages, where the programming languages include object-oriented programming languages and conventional procedural programming languages. The computer-readable program instruments may be executed entirely on a user computer, executed partially on the user computer, executed as a stand-alone software package, executed partially on the user computer and partially on a remote computer, or executed entirely on the remote computer or a server. In a situation that the remote computer is involved, the remote computer may be connected to the user computer by means of any kind of network, including the LAN or the WAN, or the remote computer may be connected to an external computer (for example, the remote computer is connected through the Internet by an Internet service provider). In some embodiments, the status information of the computer-readable program instructions may be used to custom-make an electronic circuit, such as a programmable logic circuit, a field programmable gate array (FPGA), or a programmable logic array (PLA), and the electronic circuit may execute the computer-readable program instructions, so as to implement all the aspects of the present disclosure.

These computer program instructions may be provided for a general-purpose computer, a special-purpose computer, or a processing unit of other programmable data processing apparatuses to generate a machine, such that the instructions generate an apparatus for implementing a specified function/action in one or more blocks in the flow charts and/or the block diagrams when executed by a computer or a processing unit of other programmable data processing apparatuses. These computer-readable program instructions may also be stored in the computer-readable storage medium, and these instructions cause a computer, a programmable data processing apparatus, and/or other devices to work in a particular manner, such that the computer-readable medium storing instructions may include an article of manufacture that includes instructions which may implement various aspects of the function/action specified in one or more blocks in the flow charts and/or the block diagrams.

The computer-readable program instructions may also be loaded onto a computer, other programmable data processing apparatuses, or other devices, such that a series of operation steps may be executed on the computer, the other programmable data processing apparatuses, or the other devices to generate a computer-implemented process. Therefore, the instructions executed on the computer, the other programmable data processing apparatuses, or the other devices implement a specified function/action in one or more blocks in the flow charts and/or the block diagrams.

The flow charts and block diagrams in the accompanying drawings illustrate system structures, functions and operations, which may be implemented by devices, methods and computer program products according to multiple embodiments of the present disclosure. In this regard, each block in the flow charts or the block diagrams may represent a module, a program segment, or a part of an instruction, which may include one or more executable instructions configured to implement logical functions as specified. It should also be noted that in some alternative implementations, functions noted in the blocks may also occur in sequences different from those in the accompanying drawings. For example, two continuous blocks may be actually implemented basically in parallel, sometimes implemented in reverse sequences, which depends on the involved functions. It should also be noted that each block in the block diagrams and/or the flow charts, and combinations of the blocks in the flow charts and/or the block diagrams, may be implemented by using dedicated hardware-based systems that execute specified functions or actions, or may be implemented by using combinations of dedicated hardware and computer instructions.

Various embodiments of the present disclosure have been described above. The above description is exemplary, not exhaustive, and not limited to the embodiments disclosed. Many modifications and variations are apparent to those of ordinary skill in the art without departing from the scope and spirit of the embodiments described. Selection of terms used herein aims to best explain the principles, practical applications, or technological improvements made to the technology in the market of each embodiment, or enables other ordinary skill in the technical field to understand the embodiments disclosed herein.

Some example implementations of the present disclosure are listed below.

Example 1. A method for split learning, including: generate a multi-classification label set corresponding to an object set based on a binary classification label set corresponding to the object set; receive an embedding vector set from a non-label party model, wherein an embedding vector in the embedding vector set is generated based on a feature of an object in the object set; and generate a label party model based on the embedding vector set and the multi-classification label set.

Example 2. The method according to Example 1, wherein generating the multi-classification label set corresponding to the object set includes: flip a binary classification label subset in the binary classification label set to obtain a flipped binary classification label set; and generate a multi-classification label for each classification label in the flipped binary classification label set to obtain the multi-classification label set.

Example 3. The method according to Example 2, wherein flipping the binary classification label subset in the binary classification label set includes: randomly select a binary classification label from the binary classification label set at a predetermined probability to form the binary classification label subset; and flip each label in the binary classification label subset to a further label of a binary classification label.

Example 4. The method according to Example 2, wherein generating the multi-classification label for each label in the flipped binary classification label set includes: uniformly divide the flipped binary classification label set into a plurality of flipped binary classification label subsets, wherein each of the plurality of flipped binary classification label subsets includes one classified label; and generate the multi-classification label for each flipped binary classification label in the plurality of flipped binary classification label subsets, a multi-classification label with same classification is generated for labels in a same binary classification label subset, and a multi-classification label with a different classification is generated for labels in a different binary classification label subset.

Example 5. The method according to Example 1, wherein the label party model includes a first network and a second network.

Example 6. The method according to Example 5, wherein generating the label party model based on the embedding vector set and the multi-classification label set includes: determine a ratio of a number of first labels to a number of second labels in the binary classification label set; determine a first weight for a label corresponding to the first labels and a second weight for a label corresponding to the second labels in the multi-classification label set, wherein a ratio of the first weight to the second weight is inversely proportional to the ratio of the number of the first labels to the number of the second labels; apply the first network to the embedding vector set to obtain a multi-classification result set of the first network; and generate a first loss function for the first network in the label party model based on the multi-classification result set, the multi-classification label set, the first weight and the second weight.

Example 7. The method according to Example 5, wherein generating the label party model includes: apply the first network to embedding vectors in the embedding vector set to obtain a multi-classification result of the first network; generate a first loss function for the first network based on the multi-classification result and corresponding multi-classification labels in the multi-classification label set; and train the first network based on the first loss function.

Example 8. The method according to Example 7, wherein generating the label party model further includes: determine a feedback gradient vector for the embedding vectors based on the embedding vectors, the multi-classification result and the multi-classification labels; and send the feedback gradient vector to the non-label party model.

Example 9. The method according to Example 5, wherein the second network is a second parallel network, and generating the label party model further includes: generate a second parallel network loss function for the second parallel network based on the embedding vectors and corresponding binary classification labels in the binary classification label set; and train the second parallel network based on the second parallel network loss function.

Example 10. The method according to Example 9, wherein generating the second parallel network loss function for the second parallel network includes: apply the second parallel network to the embedding vectors to determine a second parallel network classification result; and generate the second parallel network loss function for the second parallel network based on the second parallel network classification result and the corresponding binary classification labels.

Example 11. The method according to Example 5, wherein the second network is a second serial network, and generating the label party model further includes: generate a second serial network loss function for the second serial network based on embedding vectors, corresponding binary classification labels in the binary classification label set and the first network; and train the second serial network based on the second serial network loss function.

Example 12. The method according to Example 11, where generating the second serial network loss function for the second serial network includes: apply the second serial network to the multi-classification result to determine a second serial network classification result; and generate the second serial network loss function for the second serial network based on the second serial network classification result and the binary classification labels.

Example 13. An apparatus for split learning, including: a multi-classification label generation module, configured to generate a multi-classification label set corresponding to an object set based on a binary classification label set corresponding to the object set; an embedding vector receiving module, configured to receive an embedding vector set from a non-label party model, wherein an embedding vector in the embedding vector set is generated based on a feature of an object in the object set; and a label party model generation module, configured to generate a label party model based on the embedding vector set and the multi-classification label set.

Example 14. The apparatus according to Example 13, wherein the multi-classification label generation module includes: a binary classification label flip module, configured to flip a binary classification label subset in the binary classification label set to obtain a flipped binary classification label set; and a flip multi-classification generation module, configured to generate a multi-classification label for each classification label in the flipped binary classification label set to obtain the multi-classification label set.

Example 15. The apparatus according to Example 14, wherein the binary classification label flip module includes: a random label selection module, configured to randomly select a binary classification label from the binary classification label set at a predetermined probability to form the binary classification label subset; and a random label flip module, configured to flip each label in the binary classification label subset to another label of a binary classification label.

Example 16. The apparatus according to Example 14, wherein the flip multi-classification generation module includes: a binary classification label subset dividing module, configured to uniformly divide the flipped binary classification label set into a plurality of flipped binary classification label subsets, where each of the plurality of flipped binary classification label subsets includes one classified label; and a multi-classification label generation definition module, configured to generate the multi-classification label for each flipped binary classification label in the plurality of flipped binary classification label subsets, wherein a multi-classification label with same classification is generated for labels in a same binary classification label subset, and a multi-classification label with a different classification is generated for labels in a different binary classification label subset.

Example 17. The apparatus according to Example 13, wherein the label party model includes a first network and a second network.

Example 18. The apparatus according to Example 17, wherein the label party model generation module includes: a label ratio determination module, configured to determine a ratio of a number of first labels to a number of second labels in the binary classification label set; a weight ratio determination module, configured to determine a first weight for a label corresponding to the first labels and a second weight for a label corresponding to the second labels in the multi-classification label set, wherein a ratio of the first weight to the second weight is inversely proportional to the ratio of the number of the first labels to the number of the second labels; a weighted classification result obtaining module, configured to apply the first network to the embedding vector set to obtain a multi-classification result set of the first network; and a weighted loss function generation module, configured to generate a first loss function for the first network in the label party model based on the multi-classification result set, the multi-classification label set, the first weight and the second weight.

Example 19. The apparatus according to Example 17, where the label party model generation module includes: a first network applying module, configured to apply the first network to embedding vectors in the embedding vector set to obtain a multi-classification result of the first network; a first loss function generation module, configured to generate a first loss function for the first network based on the multi-classification result and corresponding multi-classification labels in the multi-classification label set; and a first loss function using module, configured to train the first network based on the first loss function.

Example 20. The apparatus according to Example 19, wherein the label party model generation module further includes: a feedback gradient vector determination module, configured to determine a feedback gradient vector for the embedding vectors based on the embedding vectors, the multi-classification result and the multi-classification labels; and a feedback gradient vector sending module, configured to send the feedback gradient vector to the non-label party model.

Example 21. The apparatus according to Example 17, wherein the second network is a second parallel network, and the label party model generation module further includes: a parallel loss function generation module, configured to generate a second parallel network loss function for the second parallel network based on embedding vectors and corresponding binary classification labels in the binary classification label set; and a parallel loss function using module, configured to train the second parallel network based on the second parallel network loss function.

Example 22. The apparatus according to Example 21, where the parallel loss function generation module includes: a parallel classification result determination module, configured to apply the second parallel network to the embedding vectors to determine a second parallel network classification result; and a parallel classification result using module, configured to generate the second parallel network loss function for the second parallel network based on the second parallel network classification result and the corresponding binary classification labels.

Example 23. The apparatus according to Example 17, wherein the second network is a second serial network, and generating a label party model further includes: a serial loss function generation module, configured to generate a second serial network loss function for the second serial network based on embedding vectors, corresponding binary classification labels in the binary classification label set and the first network; and a serial loss function using module, configured to train the second serial network based on the second serial network loss function.

Example 24. The apparatus according to Example 23, wherein generating a second serial network loss function for the second serial network includes: a serial classification result determination module, configured to apply the second serial network to the multi-classification result to determine a second serial network classification result; and a serial classification result using module, configured to generate the second serial network loss function for the second serial network based on the second serial network classification result and the binary classification labels.

Example 25. An electronic device, including: a processor; and a memory coupled to the processor, wherein the memory has instructions stored in the memory, the instructions, when being executed by the processor, cause the electronic device to execute actions including: generate a multi-classification label set corresponding to an object set based on a binary classification label set corresponding to the object set; receive an embedding vector set from a non-label party model, wherein an embedding vector in the embedding vector set is generated based on a feature of an object in the object set; and generate a label party model based on the embedding vector set and the multi-classification label set.

Example 26. The electronic device according to Example 25, wherein the action of generating the multi-classification label set corresponding to the object set includes: flip a binary classification label subset in the binary classification label set to obtain a flipped binary classification label set; and generate a multi-classification label for each classification label in the flipped binary classification label set to obtain the multi-classification label set.

Example 27. The electronic device according to Example 26, wherein the action of flipping the binary classification label subset in the binary classification label set includes: randomly select a binary classification label from the binary classification label set at a predetermined probability to form the binary classification label subset; and flip each label in the binary classification label subset to a further label of a binary classification label.

Example 28. The electronic device according to Example 26, wherein the action of generating the multi-classification label for each label in the flipped binary classification label set includes: uniformly divide the flipped binary classification label set into a plurality of flipped binary classification label subsets, wherein each of the plurality of flipped binary classification label subsets includes one classified label; and generate the multi-classification labels for each flipped binary classification label in the plurality of flipped binary classification label subsets, wherein a multi-classification label with same classification is generated for labels in a same binary classification label subset, and a multi-classification label with a different classification is generated for labels in a different binary classification label subset.

Example 29. The electronic device according to Example 25, where the label party model includes a first network and a second network.

Example 30. The electronic device according to Example 29, wherein the action of generating the label party model based on the embedding vector set and the multi-classification label set includes: determine a ratio of a number of first labels to a number of second labels in the binary classification label set; determine a first weight for a label corresponding to the first labels and a second weight for a label corresponding to the second labels in the multi-classification label set, where a ratio of the first weight to the second weight is inversely proportional to the ratio of the number of the first labels to the number of the second labels; apply the first network to the embedding vector set to obtain a multi-classification result set of the first network; and generate a first loss function for the first network in the label party model based on the multi-classification result set, the multi-classification label set, the first weight and the second weight.

Example 31. The electronic device according to Example 29, where the action of generating the label party model includes: apply the first network to embedding vectors in the embedding vector set to obtain a multi-classification result of the first network; generate a first loss function for the first network based on the multi-classification result and corresponding multi-classification labels in the multi-classification label set; and train the first network based on the first loss function.

Example 32. The electronic device according to Example 31, wherein the action of generating the label party model further includes: determine a feedback gradient vector for the embedding vectors based on the embedding vectors, the multi-classification result and the multi-classification labels; and send the feedback gradient vector to the non-label party model.

Example 33. The electronic device according to Example 29, wherein the second network is a second parallel network, and the action of generating the label party model further includes: generate a second parallel network loss function for the second parallel network based on embedding vectors and corresponding binary classification labels in the binary classification label set; and train the second parallel network based on the second parallel network loss function.

Example 34. The electronic device according to Example 33, wherein the action of generating a second parallel network loss function for the second parallel network includes: apply the second parallel network to the embedding vectors to determine a second parallel network classification result; and generate the second parallel network loss function for the second parallel network based on the second parallel network classification result and the corresponding binary classification labels.

Example 35. The electronic device according to Example 29, wherein the second network is a second serial network, and the action of generating the label party model further includes: generate a second serial network loss function for the second serial network based on embedding vectors, corresponding binary classification labels in the binary classification label set and the first network; and train the second serial network based on the second serial network loss function.

Example 36. The electronic device according to Example 35, wherein the action of generating the second serial network loss function for the second serial network includes: apply the second serial network to the multi-classification result to determine a second serial network classification result; and generate the second serial network loss function for the second serial network based on the second serial network classification result and the binary classification labels.

Example 37. A computer-readable storage medium, storing one or more computer instructions, wherein the one or more computer instructions are executed by a processor to implement the method according to any of Examples 1-12.

Example 38. A computer program product, tangibly stored on a computer-readable medium and including computer-executable instructions, wherein the computer-executable instructions, when being executed by a device, cause the device to execute the method according to any of Examples 1-12.

Although the present disclosure has been described in language specific to structural features and/or method logical actions, it should be understood that the subject matter defined in the appended claims may not necessarily be limited to the specific features or actions described above. On the contrary. the specific features and actions described above are merely example forms to implement the claims.

I/we claim:

1. A method for split learning, comprising:
generating a multi-classification label set corresponding to an object set based on a binary classification label set corresponding to the object set;
receiving an embedding vector set from a non-label party model, wherein an embedding vector in the embedding vector set is generated based on a feature of an object in the object set; and
generating a label party model based on the embedding vector set and the multi-classification label set.

2. The method according to claim 1, wherein generating the multi-classification label set corresponding to the object set comprises:
flipping a binary classification label subset in the binary classification label set to obtain a flipped binary classification label set; and
generating a multi-classification label for each classification label in the flipped binary classification label set to obtain the multi-classification label set.

3. The method according to claim 2, wherein flipping the binary classification label subset in the binary classification label set comprises:
randomly selecting binary classification labels from the binary classification label set at a predetermined probability to form the binary classification label subset; and
flipping each label in the binary classification label subset to a further label of a binary classification label.

4. The method according to claim 2, wherein generating the multi-classification label for each classification label in the flipped binary classification label set comprises:
uniformly dividing the flipped binary classification label set into a plurality of flipped binary classification label subsets, wherein each of the plurality of flipped binary classification label subsets comprises one classified label; and
generating the multi-classification label for each flipped binary classification label in the plurality of flipped binary classification label subsets, wherein a multi-classification label is generated for labels in a same binary classification label subset, and a multi-classification label with a different classification is generated for labels in a different binary classification label subset.

5. The method according to claim 1, wherein the label party model comprises a first network and a second network.

6. The method according to claim 5, wherein generating the label party model comprises:
determining a ratio of a number of first labels to a number of second labels in the binary classification label set;
determining a first weight for a label corresponding to the first labels and a second weight for a label corresponding to the second labels in the multi-classification label set, wherein a ratio of the first weight to the second weight is inversely proportional to the ratio of the number of the first labels to the number of the second labels;
applying the first network to the embedding vector set to obtain a multi-classification result set of the first network; and
generating a first loss function for the first network in the label party model based on the multi-classification result set, the multi-classification label set, the first weight, and the second weight.

7. The method according to claim 5, wherein generating the label party model comprises:
applying the first network to embedding vectors in the embedding vector set to obtain a multi-classification result of the first network;
generating a first loss function for the first network based on the multi-classification result and corresponding multi-classification labels in the multi-classification label set; and
training the first network based on the first loss function.

8. The method according to claim 7, wherein generating the label party model further comprises:
determining a feedback gradient vector for the embedding vectors based on the embedding vectors, the multi-classification result, and the multi-classification labels; and
sending the feedback gradient vector to the non-label party model.

9. The method according to claim 5, wherein the second network is a second parallel network, and generating the label party model further comprises:
generating a second parallel network loss function for the second parallel network based on the embedding vectors and corresponding binary classification labels in the binary classification label set; and
training the second parallel network based on the second parallel network loss function.

10. The method according to claim 9, wherein generating the second parallel network loss function for the second parallel network comprises:
applying the second parallel network to the embedding vectors to determine a second parallel network classification result; and
generating the second parallel network loss function for the second parallel network based on the second parallel network classification result and the corresponding binary classification labels.

11. The method according to claim 5, wherein the second network is a second serial network, and generating the label party model further comprises:
generating a second serial network loss function for the second serial network based on the embedding vectors, corresponding binary classification labels in the binary classification label set, and the first network; and
training the second serial network based on the second serial network loss function.

12. The method according to claim 11, wherein generating the second serial network loss function for the second serial network comprises:
applying the second serial network to the multi-classification result to determine a second serial network classification result; and
generating the second serial network loss function for the second serial network based on the second serial network classification result and the binary classification labels.

13. An electronic device, comprising:
a processor; and
a memory coupled to the processor, wherein the memory has instructions stored therein, and the instructions, when being executed by the processor, cause the electronic device to:
generate a multi-classification label set corresponding to an object set based on a binary classification label set corresponding to the object set;
receive an embedding vector set from a non-label party model, wherein an embedding vector in the embedding vector set is generated based on a feature of an object in the object set; and
generate a label party model based on the embedding vector set and the multi-classification label set.

14. The electronic device of claim 13, wherein the electronic device being caused to generate the multi-classification label set corresponding to the object set comprises being caused to:
flip a binary classification label subset in the binary classification label set to obtain a flipped binary classification label set; and
generate a multi-classification label for each classification label in the flipped binary classification label set to obtain the multi-classification label set.

15. The electronic device according to claim 14, wherein the electronic device being caused to flip the binary classification label subset in the binary classification label set comprises being caused to:
randomly select binary classification labels from the binary classification label set at a predetermined probability to form the binary classification label subset; and
flip each label in the binary classification label subset to a further label of a binary classification label.

16. The electronic device according to claim 14, wherein the electronic device being caused to generate the multi-classification label for each classification label in the flipped binary classification label set comprises being caused to:
uniformly divide the flipped binary classification label set into a plurality of flipped binary classification label subsets, wherein each of the plurality of flipped binary classification label subsets comprises one classified label; and
generate the multi-classification label for each flipped binary classification label in the plurality of flipped binary classification label subsets, wherein a multi-classification label is generated for labels in a same binary classification label subset, and a multi-classification label with a different classification is generated for labels in a different binary classification label subset.

17. The electronic device according to claim 13, wherein the label party model comprises a first network and a second network.

18. The electronic device according to claim 17, wherein the electronic device being caused to generate the label party model comprises being caused to:
determine a ratio of a number of first labels to a number of second labels in the binary classification label set;
determine a first weight for a label corresponding to the first labels and a second weight for a label corresponding to the second labels in the multi-classification label set, wherein a ratio of the first weight to the second weight is inversely proportional to the ratio of the number of the first labels to the number of the second labels;
apply the first network to the embedding vector set to obtain a multi-classification result set of the first network; and
generate a first loss function for the first network in the label party model based on the multi-classification result set, the multi-classification label set, the first weight, and the second weight.

19. The electronic device according to claim 17, wherein the electronic device being caused to generate the label party model comprises being caused to:
apply the first network to embedding vectors in the embedding vector set to obtain a multi-classification result of the first network;
generate a first loss function for the first network based on the multi-classification result and corresponding multi-classification labels in the multi-classification label set; and
train the first network based on the first loss function.

20. A non-transitory computer-readable storage medium, storing computer-executable instructions, wherein the computer-executable instructions, when being executed by a processor, cause an electronic device to:
generate a multi-classification label set corresponding to an object set based on a binary classification label set corresponding to the object set;
receive an embedding vector set from a non-label party model, wherein an embedding vector in the embedding vector set is generated based on a feature of an object in the object set; and
generate a label party model based on the embedding vector set and the multi-classification label set.
